(19) United States
(12) Patent Application Publication
(10) Pub. No.: US 2023/0303392 A1
(43) Pub. Date: Sep. 28, 2023

(54) HYDROGEN PROCESS

(71) Applicant: JOHNSON MATTHEY PUBLIC LIMITED COMPANY, London (GB)

(72) Inventors: Youxin CUI, Billingham, Cleveland (GB); Monica GARCIA, Billingham, Cleveland (GB); Pauline Elizabeth GLEN, Billingham, Cleveland (GB); Norman MACLEOD, Billingham, Cleveland (GB); Neetisha MISTRY, Billingham, Cleveland (GB); Michael Thomas NICHOLSON, Billingham, Cleveland (GB); Simone ROLOFF-STANDRING, Billingham, Cleveland (GB); Thomas SMITH, Billingham, Cleveland (GB); Helen Elizabeth STANNESS, Billingham, Cleveland (GB); Melanie Andrea STANWAY, Billingham, Cleveland (GB); Kaamila UN DIN, Billingham, Cleveland (GB)

(21) Appl. No.: 18/041,628

(22) PCT Filed: Sep. 14, 2021
(86) PCT No.: PCT/GB2021/052374

§ 371 Date: Feb. 14, 2023

(30) Foreign Application Priority Data
Oct. 9, 2020 (GB) 2016050

(51) Int. Cl. C01B 3/38

(52) U.S. Cl. CPC C01B 3/382; C01B 2203/0283; C01B 2203/0405; C01B 2203/043; C01B 2203/0475; C01B 2203/0495; C01B 2203/1076; C01B 2203/146

(57) ABSTRACT

A process for the production of hydrogen is described, the process comprises the steps of: (a) generating a synthesis gas comprising hydrogen, carbon monoxide, carbon dioxide and steam in a synthesis gas generation unit; (b) increasing the hydrogen content of the synthesis gas and decreasing the carbon monoxide content by subjecting it to one or more water-gas shift stages in a water-gas shift unit to provide a hydrogen-enriched gas, (c) cooling the hydrogen-enriched gas and separating condensed water therefrom, (d) passing the resulting de-watered hydrogen-enriched gas to a carbon dioxide separation unit to provide a carbon dioxide gas stream and a hydrogen gas stream, wherein the synthesis gas from step (a) is fed without adjustment of the carbon monoxide content to a water gas shift reactor.

The present invention relates to a process for the production of hydrogen, in particular processes for the production of hydrogen including a water gas shift stage performed using copper catalysts.

Processes for the production of hydrogen are known and typically comprise catalytic steam reforming of natural gas to produce a synthesis gas comprising hydrogen, carbon dioxide, carbon monoxide and steam, followed by catalytic water-gas shift to increase the hydrogen content of the synthesis gas and convert carbon monoxide to carbon dioxide, followed by removal of the carbon dioxide by absorption. The water gas shift reaction is exothermic and to achieve suitably low carbon monoxide exit concentrations, is conventionally performed in two stages, first using an iron-catalysed high temperature shift catalyst that reduces the carbon monoxide content and, following cooling, a subsequent low-temperature shift stage using a copper catalyst.

There is a drive to greater efficiency in the process and attempts have been made to perform the water-gas shift stage using copper catalysts at higher inlet temperatures, either adiabatically, or with cooling, under medium-temperature shift conditions. However copper catalysts are susceptible to thermal degradation and the lifetime of the copper catalysts used at the higher inlet temperatures and with higher carbon monoxide content feeds is relatively short requiring more frequent shutdown of the hydrogen process. The Applicants have discovered that modification of copper catalysts with silica can improve the lifetime of the copper catalyst at the more demanding conditions, resulting in an enhanced efficiency hydrogen process.

JP2000126597 discloses a catalyst suitable for low-temperature shift comprising 20-65% copper oxide, 10-70 wt.% zinc oxide and 0.5-5 wt.% of silicon oxide, which is claimed to have long-term stability. However, a hydrogen process in which a water-gas shift stage is operated under adiabatic or cooled medium-temperature shift conditions without prior adjustment of the carbon monoxide content of the synthesis gas is not disclosed.

Accordingly the invention provides a process for the production of hydrogen comprising the steps of: (a) generating a synthesis gas comprising hydrogen, carbon monoxide, carbon dioxide and steam in a synthesis gas generation unit; (b) increasing the hydrogen content of the synthesis gas and decreasing the carbon monoxide content by subjecting it to one or more water-gas shift stages in a water-gas shift unit to provide a hydrogen-enriched gas, (c) cooling the hydrogen-enriched gas and separating condensed water therefrom, (d) passing the resulting de-watered hydrogen-enriched gas to a carbon dioxide separation unit to provide a carbon dioxide gas stream and a hydrogen gas stream, wherein the synthesis gas from step (a) is fed without adjustment of the carbon monoxide content to a water gas shift reactor, operated adiabatically or with cooling, at an inlet temperature in the range 200 to 280° C. and an exit temperature below 360° C., and containing a catalyst comprising 30 to 70% by weight of copper, expressed as CuO, combined with zinc oxide, alumina and silica, said catalyst having a silica content, expressed as SiO₂, in the range of 0.1 to 5.0 wt%.

The synthesis gas, comprising hydrogen, carbon monoxide, carbon dioxide and steam provided in step (a) may be generated by any suitable means. The synthesis gas generation may comprise one or more steps selected from adiabatic pre-reforming, catalytic steam reforming in a fired- or gas-heated reformer, autothermal reforming, and catalytic partial oxidation, applied to a gaseous or vapourised hydrocarbon such as natural gas, naphtha or a refinery off-gas. Alternatively, the synthesis gas generation may comprise non-catalytic partial oxidation or gasification of a carbonaceous feedstock such as coal, biomass or municipal waste, optionally followed by one or more stages of catalytic steam reforming or autothermal reforming.

In some embodiments, the synthesis gas generation unit comprises an autothermal reformer, fed with a reformed synthesis gas obtained from an upstream adiabatic pre-reformer or a fired steam reformer or gas-heated reformer.

In adiabatic pre-reforming, a mixture of hydrocarbon and steam, typically at a steam to carbon ratio in the range 1-4, is passed at an inlet temperature in the range 300 to 620° C. and a pressure in the range of 10-80 bar abs to a fixed bed of pelleted Ni-containing pre-reforming catalyst. Such catalysts typically comprise ≥ 40% wt Ni (expressed as NiO) with alumina and promoter compounds, such as silica and magnesia.

In a fired steam reformer and in a gas heated reformer, a mixture of hydrocarbon and steam is fed to a plurality of externally heated catalyst-filled tubes. The reforming catalyst used in the fired or gas-heater reformer typically comprises nickel at levels in the range 5-30% wt, supported on shaped refractory oxides, such as alpha alumina, magnesium aluminate or calcium aluminate. Alternatively, structured catalysts, wherein a nickel or precious metal catalyst is provided as a coated layer on a formed metal or ceramic structure may be used, or the catalysts may be provided in a plurality of containers disposed within the tubes. Steam reforming reactions take place in the tubes over the steam reforming catalyst at temperatures above 350° C. and typically the process fluid exiting the tubes is at a temperature in the range 650 - 950° C. The tubes are heated by a heat exchange medium flowing around the outside of the tubes that may have a temperature in the range 900 to 1300° C. In a fired reformer this heat is provided by combustion of a fuel gas with air. In a gas-heated reformer, the heat may be provided by a flue gas but is preferably an autothermally-reformed synthesis gas. The pressure in the tubes may be in the range 10-80 bar abs.

In an autothermal reformer, the feed gas is partially combusted in a burner apparatus mounted usually near the top of the reformer. The partially combusted gas is then passed adiabatically through a bed of a steam reforming catalyst disposed below the burner apparatus, to bring the gas composition towards equilibrium. Heat for the endothermic steam reforming reaction is supplied by the hot, partially combusted reformed gas. As the partially combusted reformed gas contacts the steam reforming catalyst it is cooled by the endothermic steam reforming reaction to temperatures in the range 900-1100° C. The bed of steam reforming catalyst in the secondary reformer typically comprises nickel at levels in the range 5-30% wt, supported on shaped refractory oxides, but layered beds may be used wherein the uppermost catalyst layer comprises a precious metal, such as Pt or Rh, on a zirconia support. Such steam reforming apparatus and catalysts are commercially available.

In a preferred process, the syngas generation stage comprises reforming a hydrocarbon, particularly natural gas, in a gas-heated reformer to produce a gas stream comprising hydrogen, carbon monoxide, carbon dioxide and steam, and an autothermal reforming stage in which the reformed gas is further reformed in a autothermal reformer using oxygen to provide a synthesis gas stream comprising hydrogen, carbon monoxide, carbon dioxide and steam.

The synthesis gas comprises hydrogen, carbon monoxide, carbon dioxide, steam, and may contain a small amount of unreacted methane, and smaller amounts of inert gases such as nitrogen and argon. The hydrogen content of the synthesis gas, on a wet gas basis, i.e. taking the steam into account, may be in the range 30 to 50% vol. The carbon monoxide content of the synthesis gas, on a wet gas basis, may be in the range 6 to 20% vol. The composition of the synthesis gas may also be expressed on a dry gas basis. The hydrogen content of the synthesis gas, on a dry gas basis, i.e. not taking the steam into account, may be in the range 60 to 80% vol. The carbon monoxide content of the synthesis gas, on a dry gas basis, may be in the range 10 to 30% vol.

In the process, the hydrogen content of the synthesis gas mixture is increased by subjecting it to one or more water-gas shift stages thereby producing a hydrogen-enriched gas and at the same time converting carbon monoxide in the reformed gas to carbon dioxide. The reaction may be depicted as follows:

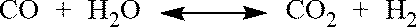

The steam to dry gas molar ratio in the feed to the water gas shift unit may be in the range 0.7 to 2.0:1, preferably 0.7 to 1.2:1, more preferably 0.7 to 1.0:1. Where the synthesis gas generation is performed with an excess of steam it will not be necessary to add steam to the synthesis gas mixture to ensure sufficient steam is available for the water-gas shift reaction. However, supplemental steam may be added if desired.

The synthesis gas may be subjected in the water-gas shift unit to one or more water-gas shift stages to form a hydrogen-enriched gas stream, or “shifted” gas stream.

In the present invention, the water gas shift unit comprises at least one stage of medium-temperature shift, operated adiabatically (MTS), or with cooling (so-called isothermal shift, ITS). Accordingly, in the present invention, the water-gas shift unit comprises at least one reactor operated adiabatically or with cooling with an inlet temperature in the range 200 to 280° C. and an exit temperature below 360° C. In contrast to prior methods, this water gas shift stage is not operated downstream of a conventional high temperature shift stage. Accordingly, in the present invention the synthesis gas containing hydrogen and carbon monoxide is cooled to an inlet temperature in the range 200 to 280° C. and passed, without prior adjustment of the carbon monoxide content, adiabatically or with cooling, through a bed of the catalyst.

Using an isothermal shift stage, i.e. with heat exchange in the shift converter such that the exothermic reaction in the catalyst bed occurs in contact with heat exchange surfaces that remove heat, offers the potential to use the synthesis gas stream in a very efficient manner. Whereas the term “isothermal” is used to describe a cooled shift converter, there may be a relatively small increase in temperature of the gas between inlet and outlet, so that the temperature of the hydrogen-enriched gas stream at the exit of the isothermal shift converter may be between 1 and 25° C. higher than the inlet temperature. The inlet temperature for the isothermal shift reactor may be higher than in an adiabatic reactor, for example, the inlet temperature for the isothermal shift reactor may be in the range 230 to 250° C. The coolant conveniently may be water under pressure such that partial, or complete, boiling takes place. The water can be in tubes surrounded by catalyst or vice versa. The resulting steam can be used, for example, to drive a turbine, e.g. for electrical power, or to provide process steam for supply to the process. In a preferred embodiment, steam generated by the isothermal shift stage is used to supplement the steam used in steam reforming. This improves the efficiency of the process.

If desired, an adiabatic low-temperature shift stage may be included downstream of the isothermal shift stage to maximise the hydrogen enrichment upstream of the carbon dioxide removal stage. However, we have found that excellent efficiency may be provided by a single isothermal shift converter.

The catalyst used in the reactor operated under the MTS or ITS conditions comprises 30 to 70% by weight of copper, expressed as CuO, combined with zinc oxide, alumina and silica, said catalyst having a silica content, expressed as SiO₂, in the range of 0.1 to 5.0 wt%.

The copper content, expressed as CuO, is preferably 45 to 65% wt. The weight ratio of Cu:Zn (expressed as CuO:ZnO) may be in the range of 1.4:1 to 3.0:1. The zinc content, expressed as ZnO, may be in the range 20-50% wt, preferably 20-40% wt, The aluminium content, expressed as Al₂O₃ may be in the range 5-40% wt, preferably 8-25% wt. One or more promoter metal oxides, selected from oxides of Mg, Co, Mn, V, Ti, Zr or rare earths, may optionally be present in an mount in the range 0-5% wt. The promoters may stabilise the copper or enhance the properties of the support phase. Magnesium and zirconium compounds are preferred at 0.1-5% by weight.

The catalyst contains silica and may have a Si:Al atomic ratio in the range of 0.004 to 0.2:1. The amount of silica in the catalyst appears to be optimal when the Si:Al atomic ratio is in the range of 0.03 to 0.09:1. The amount of silica in the catalyst is therefore relatively low, and may be present in the calcined catalyst in an amount in the range of 0.1 to 5.0% by weight, preferably 0.1 to 2.0% by weight, more preferably 0.2 to 1.0% by weight.

The catalyst made by the method may have a copper surface area ≥ 40 m²/g catalyst, preferably ≥ 50 m²/g catalyst, more preferably ≥ 55 m²/g catalyst, most preferably ≥ 60 m²/g catalyst. Copper surface areas up to about 70 m²/g catalyst may be achieved. The copper surface area may be readily established by reactive frontal chromatography, for example as described in EP-A-0202824.

The BET surface area of the catalyst, as determined by nitrogen physisorption (according to ASTM Method D 3663-03), may be ≥ 75 m²/g, and is preferably ≥ 100 m²/g. BET surface areas up to about 140 m²/g may be achieved. The BET surface areas are suitably determined on a crushed pellet.

The catalyst comprises CuO and ZnO, and the maximum intensity ratio of a peak derived from the ZnO to a peak derived from the CuO, as measured by XRD, may be 0.26:1 or higher, preferably 0.30:1 or higher. These crystallographic properties arise from a combination of the composition and the catalyst preparation method.

In the catalyst, the zinc oxide, alumina and silica are not substantially reduced to metal under the water-gas shift process conditions and are generally present as the oxides in the catalyst. In contrast, the copper is more readily reduced to the active elemental form. The copper may be reduced either ex-situ or in-situ to form catalytically active copper metal crystallites before use.

The catalyst may be prepared by a single-precipitation method or a double-precipitation method with a variety of silica precursors, which may be added at one or more points during the preparation of the catalyst.

In one embodiment, the catalyst may be prepared by a method comprising the steps of: (i) forming, in an aqueous medium, an intimate mixture comprising a co-precipitate of copper and zinc compounds, with alumina and silica wherein the alumina is provided by an alumina sol, (ii) recovering, washing and drying the intimate mixture to form a dried composition, and (iii) calcining and shaping the dried composition to form the catalyst.

The co-precipitate may be prepared by mixing an acidic aqueous solution containing copper and zinc compounds in the appropriate ratio and combining this with an aqueous alkaline precipitant solution. The copper and zinc compounds are preferably nitrates. The alkaline precipitant may be an alkali-metal carbonate, an alkali metal hydroxide or a mixture thereof. The alkaline precipitant preferably comprises an alkali metal carbonate. Potassium or sodium precipitants may be used but a potassium precipitant is preferred as we have found it to be more readily removed by washing than sodium from the precipitated composition. The reaction of the alkaline precipitant with the copper and zinc compounds in the acidic solution causes the precipitation of a mixed copper-zinc co-precipitate. The precipitation may be performed at temperatures in the range of 10 to 80° C., but is preferably performed at elevated temperature, i.e. in the range 40 to 80° C., more preferably 50 to 80° C., especially 60 to 80° C., as this has been found to produce small crystallites that, after calcination, provide higher copper surface areas.

The acidic and alkaline solutions may be added one to another in a precipitation vessel but are preferably added simultaneously to the precipitation vessel such that the pH in the precipitation vessel is maintained between 6 and 9, preferably between 6 and 7 after which the resulting co-precipitate slurry is aged, preferably in a separate ageing vessel, at a temperature in the range of 10 to 80° C., preferably in the range of 40 to 80° C., more preferably 50 to 80° C., especially 60 to 80° C., to form crystalline compounds, preferably crystalline hydroxycarbonate compounds, of copper and zinc. The co-precipitation and ageing are preferably operated to produce malachite [Cu₂(CO₃)(OH)²], smithsonite [ZnCO₃] and/or zincian malachite [(Cu/Zn)₂(CO₃)(OH)₂] phases, which may be determined by XRD.

The catalyst may be prepared using an alumina sol. An alumina sol is an aqueous colloidal dispersion of aluminium hydroxide, including boehmite and pseudo boehmite. The pH of the dispersion may suitably be < 7, preferably in the range 3 to 4. The alumina sol may suitably be added to the precipitation vessel. Preferably, the alumina sol is added to the precipitation vessel separately from the acidic metal solution or alkaline precipitant solution as this has been found to enhance the properties of the catalyst. Alumina sols are available commercially or may be prepared by known methods. The alumina concentration in the sol may be 30 to 200 g/litre. Particularly suitable alumina sols comprise dispersions of colloidally dispersed boehmite having a D50 average particle size in the range of 5 to 200 nm, preferably 5 to 100 nm, more preferably 5-50 nm, when dispersed. Such sols are commercially available.

The catalyst contains silica. If a silica sol is used as the source of silica, it may be added to the acidic metal solution and/or added to the precipitation vessel and/or the ageing vessel and/or the alumina sol. Particularly suitable silica sols comprise aqueous dispersions of colloidally dispersed silica having a particle size in the range of 10-20 nm. The pH of the dispersion may be < 7, preferably in the range 2 to 4. The silica concentration in the sol may be 100-400 g/litre. Such sols are available commercially as, for example, Nissan Chemicals Snowtex-O and Grace Ludox HSA.

If a water-soluble silicate, such as an alkali metal silicate, is used as the source of silica, it may be added to the alkaline precipitant solution and/or to the alumina sol and/or to the precipitation vessel and/or the ageing vessel. Suitable alkali metal silicates are soluble sodium silicates and soluble potassium silicates. Such alkali silicates are commercially available, for example, as PQ Corporation Kasil 1, PQ Corporation Kasolv 16 or Zaclon LLC Zacsil 18. Where an alkali metal silicate is used as the source of silica in the catalyst, the alkali metal in the alkali metal silicate preferably matches the alkali metal in the precipitant solution as this improves washing, recovery of catalyst and re-processing of waste solutions at scale. The amount of silicon, expressed as SiO₂, in the alkali metal silicate solution may be in the range 15-30 wt%.

If an organo-silicate, such as an alkyl-silicate of formula Si(OR)₄, where R = C1-C4 alkyl, is used as the source of silica, because it will hydrolyse when contacted with water, it is preferably added to the alumina sol or to the precipitation and/or ageing vessels.

After co-precipitation and ageing, the intimate mixture is recovered, e.g. by separation of the mother liquors using known methods such as filtering, decanting or centrifuging, and is washed to remove residual soluble salts.

Washing of the intimate mixture may be performed using conventional equipment such as plate-and-frame filter presses, for example by re-slurrying the mixture one or more times in salt-free water, or by dynamic cross-flow filtration using an Artisan thickener or Shriver thickener before recovery.

The recovered intimate mixture is dried to form a dried composition. The drying may comprise heating the damp mixture in discrete stages or continuously over an extended period until the maximum temperature is reached. The drying step may be performed at temperatures in the range of 90 to 150° C., preferably 90 to 130° C. under air or an inert gas using conventional drying equipment such as in an oven, rotary drier, spray drier or similar equipment.

The dried composition is typically in the form of a powder. The dried composition may comprise one or more hydroxycarbonates of copper and zinc, as well as alumina and silica.

The dried composition is calcined and shaped to form the catalyst. The dried composition may be calcined, i.e. heated, to convert the copper and zinc compounds, and any promoter compounds, to their respective oxides prior to shaping or, less preferably, the dried composition may be formed into shaped units before calcination. This latter method is less preferred because the calcination of shaped units generally reduces their strength and makes it more difficult to control pellet density. The calcination may be performed at temperatures in the range of 250 to 500° C. preferably 280 to 450° C.

The shaped units are preferably pellets. The dried or calcined powder may therefore be subjected to pelleting, optionally after pre-compacting the powder, which can improve the pelleting process. The pellet may suitably be a cylindrical pellet. Cylindrical pellets for carbon oxide conversion processes suitably have a diameter in the range of 2.5 to 10 mm, preferably 3-10 mm and an aspect ratio (i.e. length / diameter) in the range of 0.5 to 2.0. Alternatively, the shaped unit may be in the form of rings. In a particularly suitable embodiment, the shaped unit is in the form of a cylinder having two or more, preferably 3 to 7 grooves running along its length. Suitable domed cylindrical shapes having one or more flutes are described in our WO 2010/029325, herein incorporated by reference.

Pellets, particularly cylindrical pellets with flat or domed ends as described above, are desirably made with pellet densities in the range of 1.8 to 2.5 g/cm³, preferably 1.9 to 2.4 g/cm³. The pellet density may readily be determined by calculating the volume from the pellet dimensions and measuring its weight. As the density is increased, the interstitial volume in the shaped units is reduced, which in turn reduces the permeability of reacting gases. Therefore, for densities > 2.5 g/cm³ the reactivity of the catalyst may be less than optimal, despite the high volumetric copper content. For densities < 1.8 g/cm³ the crush strengths may be insufficient for long-term use in modern carbon-oxide conversion processes.

In another embodiment, the catalyst may be prepared by a method comprising the steps of: (a) combining an acidic copper-containing solution with an alkali metal carbonate solution in a first precipitation step to form a first precipitate, (b) combining an acidic aluminium-containing solution, further comprising one or more metal compounds selected from copper compounds, zinc compounds and promoter compounds, with a basic precipitant solution in a second precipitation step to form a second precipitate, (c) contacting the first and second precipitates together in a further mixing step to form a catalyst precursor, and (d) washing, drying and calcining the catalyst precursor to form the copper-containing catalyst, wherein a silica precursor is included in the first precipitation step, the second precipitation step or the precipitate mixing step. The washing, drying, calcining and shaping may be performed as described above.

In yet another embodiment, the catalyst may be prepared by a method comprising the steps of: (a) combining an acidic copper-containing solution with a basic precipitant solution in a first precipitation step to form a first precipitate, (b) combining an alkali metal aluminate solution with an acidic solution in a second precipitation step to form a second precipitate, (c) contacting the first and second precipitates together in a further precipitate mixing step to form a catalyst precursor, and (d) washing, drying and calcining the catalyst precursor to form the copper-containing catalyst, wherein at least 70% by weight of the copper in the catalyst is present in the first precipitate and a silica precursor is included in the first precipitation step, the second precipitation step or the precipitate mixing step. The washing, drying, calcining and shaping may be performed as described above.

Following the one or more shift stages, the hydrogen-enriched gas is cooled, for example, in a heat recovery unit, to a temperature below the dew point so that the steam condenses. The liquid water condensate may then be separated using one or more, gas-liquid separators, which may have one or more further cooling stages between them. Any coolant may be used. Preferably, cooling of the hydrogen-enriched gas stream is first carried out in heat exchange with the process condensate. As a result, a stream of heated water, which may be used to supply some or all of the steam required for steam reforming, may be formed. Thus, in one embodiment condensate recovered from the hydrogen-enriched gas is used to provide at least a portion of steam for steam reforming. Because the condensate may contain ammonia, methanol, hydrogen cyanide and CO₂, returning the condensate to form steam offers a useful way of returning hydrogen and carbon to the process.

One or more further stages of cooling are desirable. The cooling may be performed in heat exchange in one or more stages using demineralised water, air, or a combination of these. In a preferred embodiment, cooling is performed in heat exchange with one or more liquids in the CO₂ separation unit. In a particularly preferred arrangement, the hydrogen-enriched gas stream is cooled in heat exchange with condensate followed by cooling with CO₂ reboiler liquid. The cooled shifted gas may then be fed to a first gas-liquid separator, the separated gas further cooled with water and/or air and fed to a second separator, before further cooling with water and/or air and feeding to a third separator. Two or three stages of condensate separation are preferred. Some or all of the condensate may be used to generate steam for the steam reforming. Any condensate not used to generate steam may be sent to water treatment as effluent.

Typically, the hydrogen-enriched gas stream contains 10 to 30% vol of carbon dioxide (on a dry basis). In the process, after separation of the condensed water, carbon dioxide is separated from the resulting de-watered hydrogen-enriched gas stream.

The carbon dioxide separation stage may be performed using a physical wash system or a reactive wash system, preferably a reactive wash system, especially an amine wash system. The carbon dioxide may be separated by an acid gas recovery (AGR) process. In the I AGR process the de-watered hydrogen-enriched gas stream (i.e. the de-watered shifted gas) is contacted with a stream of a suitable absorbent liquid, such as an amine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating, to desorb the carbon dioxide and to give a regenerated absorbent liquid, which is then recycled to the carbon dioxide absorption stage. Alternatively, methanol or a glycol may be used to capture the carbon dioxide in a similar manner as the amine. In a preferred arrangement, at least part of this heating is in heat exchange with the hydrogen-enriched gas stream. If the carbon dioxide separation step is operated as a single pressure process, i.e. essentially the same pressure is employed in the absorption and regeneration steps, only a little recompression of the recycled carbon dioxide will be required.

The recovered carbon dioxide, e.g. from the AGR, may be compressed and used for the manufacture of chemicals, or sent to storage or sequestration or used in enhanced oil recovery (EOR) processes.

Upon the separation of the carbon dioxide, the process provides a crude hydrogen gas stream. The crude hydrogen stream may comprise 90-99% vol hydrogen, preferably 95-99% vol hydrogen with the balance comprising methane, carbon monoxide, carbon dioxide and inert gases. The methane content may be in the range 0.25-1.5% vol, preferably 0.25-0.5% vol. The carbon monoxide content may be in the range 0.5-2.5% vol, preferably 0.5-1.0% vol. The carbon dioxide content may be in the range 0.01-0.5% vol, preferably 0.01-0.1% vol.

Whereas this hydrogen gas stream may be pure enough for many duties, it is desirable to pass the hydrogen to a purification unit to provide a purified hydrogen gas and a fuel gas, so that the fuel gas may be used in the process as an alternative to external fuel sources in order to minimise the CO₂ emissions from the process.

The purification unit may suitably comprise a membrane system, a temperature swing adsorption system, or a pressure swing adsorption system. Such systems are commercially available. The purification unit is preferably a pressure-swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol, which may be compressed and used in downstream power or heating process, for example, by using it as fuel in a gas turbine (GT) or by injection into a domestic or industrial networked gas piping system. The pure hydrogen may also be used in a downstream chemical synthesis process. Thus, the pure hydrogen stream may be used to produce ammonia by reaction with nitrogen in an ammonia synthesis unit. Alternatively, the pure hydrogen may be used with a carbon dioxide-containing gas to manufacture methanol in a methanol production unit. Alternatively, the pure hydrogen may be used with a carbon-monoxide containing gas to synthesis hydrocarbons in a Fischer-Tropsch production unit. Any known ammonia, methanol or Fischer-Tropsch production technology may be used. Alternatively, the hydrogen may be used to upgrade hydrocarbons, e.g. by hydro-treating or hydro-cracking hydrocarbons in a hydrocarbon refinery, or in any other process where pure hydrogen may be used.

The invention is illustrated by reference to the accompanying drawing in which:

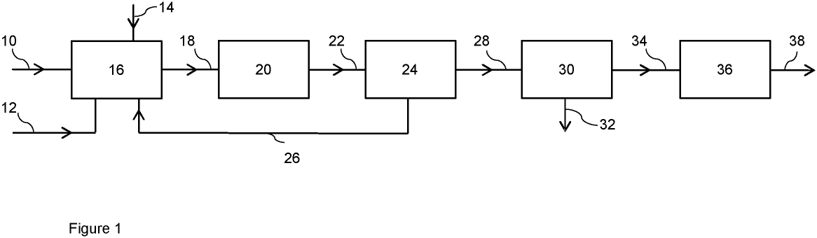

FIG. 1 is a diagrammatic flowsheet of one embodiment of the invention.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1, a stream containing methane 10, steam 12 and an oxygen stream 14 are fed to a syngas generation unit 16 comprising a gas-heated reformer and an autothermal reformer. The natural gas is steam reformed with steam in externally-heated catalyst filled tubes and the reformed gas subjected to autothermal reforming in the autothermal reformer with oxygen to generate a synthesis gas mixture comprising hydrogen, carbon dioxide, carbon monoxide and steam. The synthesis gas mixture is cooled to the desired inlet temperature in heat exchange with water to generate steam (not shown) and fed via line 18 to a water gas shift unit 20 consisting of an isothermal shift reactor containing a bed of water gas shift catalyst as described herein to generate a hydrogen-enriched gas mixture in which the hydrogen and carbon dioxide contents are increased and the steam and carbon monoxide contents decreased. Optionally, the hydrogen enriched gas may be fed to a low-temperature shift reactor included in the water gas shift unit downstream of the isothermal shift reactor. The hydrogen-enriched gas mixture is fed from the water-gas shift unit 20 via line 22 to a heat recovery unit 24 that cools the hydrogen-enriched gas to condense steam. The condensate is separated in one or more gas-liquid separators and recovered from the unit 24 via line 26. The condensate is recycled via line 26 to the synthesis gas generation unit 16 to generate steam for the gas heated reformer and/or autothermal reformer. A de-watered hydrogen enriched gas is fed from the heat recovery unit 24 via line 28 to a carbon dioxide removal unit 30 operating by means of reactive absorption. A carbon dioxide stream is recovered from the separation unit 30 by line 32. A hydrogen stream is recovered from the carbon dioxide removal unit 30 via line 34 and passed to an optional hydrogen purification unit 36 containing a membrane system, a temperature swing adsorption system, or a pressure swing adsorption system, in which impurities in the hydrogen are removed to provide a high purity hydrogen stream 38 comprising more than 99.5% vol H₂.

The invention is further illustrated by reference to the following Example.

### Example 1

A CuO/ZnO/Al₂O₃/MgO/SiO₂ formulation was produced by precipitating a mixed metal nitrate solution containing Cu, Zn and Mg nitrates against a potassium carbonate solution at a pH of 6.3-6.8 and a temperature between 65-70° C., whilst simultaneously adding a mixed colloidal dispersion containing both boehmite and silica (Snowtex ST-O) at flowrates and concentrations necessary to achieve the final composition as shown in Table 1 below. Following precipitation, the resultant slurry was aged for up to 2 hours at 65-70° C., filtered, washed, dried and calcined at 350° C. Finally, the calcined powder was pelleted to a final pellet density of 2.32 g/ml.

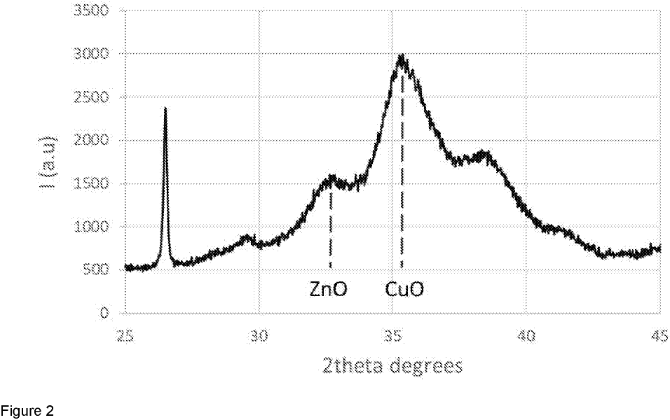

An X-ray diffraction (XRD) pattern was obtained on the powdered catalyst using a Bruker D8 diffractometer equipped with a Göbel mirror, Lynxeye detector and a copper x-ray tube. Phase identification was completed using the Bruker EVA v5.1.0.5 software. The diffraction pattern obtained is shown in FIG. 2. The intensity ratio of the ZnO peak at about 32.5° to that of the CuO peak at 35° is 0.47:1.

### Comparative Example 1

The method of Example 1 was repeated with the exception that the colloidal dispersion did not contain Snowtex ST-O.

TABLE 1

| Catalysts | CuO Wt% | ZnO Wt% | Al₂O₃ Wt% | MgO Wt% | SiO₂ Wt% | Cu surface area m²/g catalyst |
|---|---|---|---|---|---|---|
| Example 1 | 62.8 | 24.8 | 10.5 | 1.1 | 0.39 | 58 |
| Comparative Example 1 | 63.7 | 23.4 | 11.2 | 0.86 | 0.00 | 54 |

The catalysts testing was conducted using a Micro-Berty reactor, operated adiabatically. A flow of synthesis gas was fed to the reactor via a mass flow controller. The dry gas was mixed with the water feed in a packed vaporiser vessel and the wet gas transferred to the heated and stirred reactor via a heated line. A condenser system downstream of the reactor removed excess water from the gas stream. A bleed of the dry gas was fed to a calibrated IR analyser measuring CO, CO₂ and H₂ concentration.

Catalyst Reduction. In each test, 0.8 g of catalyst were charged to the reactor basket. The test was carried out at 31 barg. For catalyst reduction, 2% hydrogen in nitrogen was introduced at 100 I/h and 120 degC and then the reactor was ramped to 280 degC over 14 hours and then held for 6 hours.

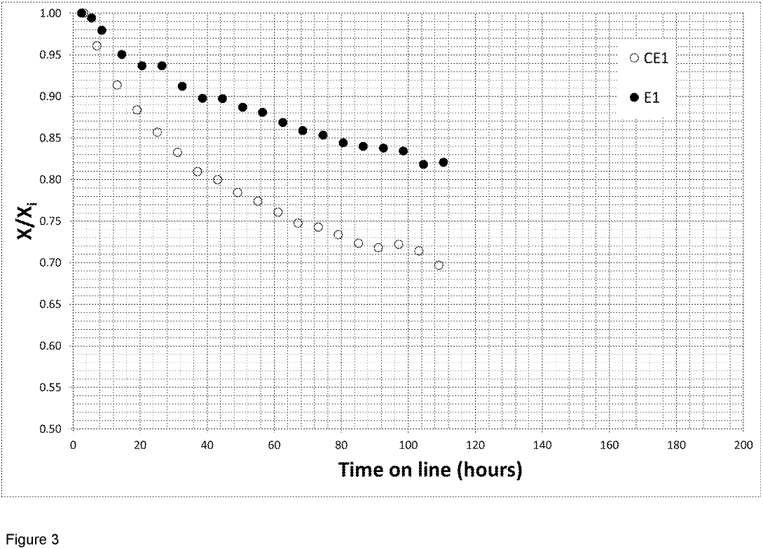

Testing. Following reduction, the dry gas composition was set to 71% H₂, 17% CO, 12% CO₂, maintaining a flow of 100 I/h. Simultaneously, water addition was started to give molar steam: dry gas ratio of 0.8:1 and the catalyst tested for 120 h at 280° C. whilst monitoring CO conversion. The results obtained are shown in FIG. 3, were the ratio of X/Xᵢ is plotted for each catalyst, where Xᵢ is defined as the initial CO conversion measured in each case, and X is the corresponding conversion after the specified period of time on-line. E1 is Example 1, CE1 is Comparative Example 1. This plot clearly shows the improved stability of the catalyst containing a small amount of silica.

In a further test, the method described above was repeated with an initial aging period of 5 days at 280° C., followed by a further aging period of 5 days at 300° C. to accelerate the ageing. In this case, at the end of both the first and the second aging periods, flow scans were carried out at 220° C. over both catalysts in order to generate conversion versus flowrate curves. These curves were then used to estimate relative activities by taking a ratio of the flowrate required on each catalyst to achieve a certain conversion. The results obtained are summarised in Table 2.

| Catalyst | Relative activity to CE1 after 5 days aging at 280° C. | Relative activity to CE1 after further 5 days aging at 300° C. |
|---|---|---|
| Example 1 | 1.21 | 1.35 |

This test again clearly demonstrates the improved performance of the catalyst containing silica.

1. A process for the production of hydrogen comprising the steps of:
(a) generating a synthesis gas comprising hydrogen, carbon monoxide, carbon dioxide and steam in a synthesis gas generation unit;
(b) increasing the hydrogen content of the synthesis gas and decreasing the carbon monoxide content by subjecting it to one or more water-gas shift stages in a water-gas shift unit to provide a hydrogen-enriched gas,
(c) cooling the hydrogen-enriched gas and separating condensed water therefrom,
(d) passing the resulting de-watered hydrogen-enriched gas to a carbon dioxide separation unit to provide a carbon dioxide gas stream and a hydrogen gas stream,
wherein the synthesis gas from step (a) is fed without adjustment of the carbon monoxide content to a water gas shift reactor, operated adiabatically or with cooling, at an inlet temperature in the range 200 to 280° C. and an exit temperature below 360° C., and containing a catalyst comprising 30 to 70% by weight of copper, expressed as CuO, combined with zinc oxide, alumina and silica, said catalyst having a silica content, expressed as SiO₂, in the range of 0.1 to 5.0 wt%.

2. The process according to claim 1, wherein the synthesis gas generation comprises one or more steps selected from adiabatic pre-reforming, catalytic steam reforming in a fired- or gas-heated reformer, autothermal reforming, and catalytic partial oxidation, applied to a gaseous or vapourised hydrocarbon such as natural gas, naphtha or a refinery off-gas.

3. The process according to claim 1, wherein the synthesis gas generation comprises non-catalytic partial oxidation or gasification of a carbonaceous feedstock such as coal, biomass or municipal waste, optionally followed by one or more stages of catalytic steam reforming or autothermal reforming.

4. The process according to claim 1, wherein the synthesis gas generation unit comprises an autothermal reformer, fed with a reformed synthesis gas obtained from an upstream adiabatic pre-reformer, a fired steam reformer or a gas-heated reformer.

5. The process according to claim 1, wherein the hydrogen content of the synthesis gas fed to the water gas shift reactor, on a wet gas basis, is in the range 30-50% vol and the carbon monoxide content of the synthesis gas fed to the water gas shift reactor, on a wet gas basis, is in the range 6-20% vol.

6. The process according to claim 1, wherein the water gas shift unit comprises a stage of medium temperature shift, or isothermal shift and optionally a downstream low-temperature shift stage.

7. The process according to claim 1, wherein the catalyst has a copper content, expressed as CuO, in the range of 45 to 65% wt.

8. The process according to claim 1, wherein the catalyst has a zinc content, expressed as ZnO, in the range 20-50% wt.

9. The process according to claim 1, wherein the catalyst has an aluminium content, expressed as Al₂O₃, in the range 5-40% wt.

10. The process according to claim 1, wherein the catalyst has a one or more promoter metal oxides, selected from oxides of Mg, Co, Mn, V, Ti, Zr or rare earths, present in an mount in the range 0.1-5% wt.

11. The process according to claim 1, wherein the catalyst has a silica content, expressed as SiO₂, in the range of 0.1 to 2.0% by weight.

12. TheA process according to claim 1, wherein the carbon dioxide removal stage is performed using a physical wash system or a reactive wash system.

13. The process according to claim 1, wherein one or more of the carbon dioxide removal unit streams are heated in heat exchange with the hydrogen-enriched gas stream.

14. The process according to claim 1, wherein the process further comprises passing the hydrogen gas stream to a purification unit to provide a purified hydrogen gas.

15. The process according to claim 14, wherein the purification unit is a pressure-swing adsorption unit or a temperature swing adsorption unit.
